(19) United States
(12) Patent Application Publication
(10) Pub. No.: US 2015/0100393 A1
(43) Pub. Date: Apr. 9, 2015

(54) TOLL CHARGING DEVICE

(71) Applicant: TSENG-FU YEH, KAOHSIUNG CITY (TW)

(72) Inventor: TSENG-FU YEH, KAOHSIUNG CITY (TW)

(21) Appl. No.: 14/045,997

(22) Filed: Oct. 4, 2013

(51) Int. Cl. G07B 15/02; G06Q 50/06; G06Q 30/02

(52) U.S. Cl. CPC G07B 15/02; G06Q 30/0284; G06Q 50/06
USPC 705/13

(57) ABSTRACT

A toll charging device includes a body having a toll unit and the toll unit is connected with a detection unit which generates a corresponding detection signal when detecting the value of a coin/bill. A control unit is connected with a counting unit and the detection unit. The control unit receives the detection signal and sets a pre-set period of time to the counting unit. At least one power output port is connected with the control unit and outputs electric power according to the time counted by the counting unit. The at least one power output port is stopped when the pre-set period of time is ended. The toll charging device charges electric/electronic devices according to the coin/bill inserted into the toll unit. The toll charging device outputs direct current and alternating current.

### FIELD OF THE INVENTION

The present invention relates to a toll charging device, and more particularly, to a toll charging device which charges the electric/electronic devices by inserting coins or bolls.

### BACKGROUND OF THE INVENTION

The electric power is a necessary element for the modern life, most of the devices used every day is powered by electric power such as cellular phones, computers, laptops. However, by the restriction of the battery technology, the stand-by period is too short, taken the cellular phones as example, the stand-by period only last few days. If the user plays games, watching videos or play music, the battery power can only last for 4 to 8 hours. Once the battery is low or shut down, the cellular phone cannot be functioned properly. Although mobile battery or power source is developed to charge the devices, the mobile battery or power source still needs to be charged before use.

For transportation, due to air pollution and global warming, the vehicles using gasoline are requested to use alternative fuel such as electric power so as to reduce the carbon production. However, the electric powered vehicles, motorcycles, and bicycles require longer charging time while a limited travel distance can reach. Besides, the charging devices and stations are way fewer than need so that the electric powered vehicles, motorcycles, and bicycles are not populated.

The present invention intends to provide a toll charging device which improve the above-mentioned shortcomings.

### SUMMARY OF THE INVENTION

The present invention relates to a toll charging device and comprises a body having a toll unit which is connected with a detection unit. The detection unit detects the value of a coin/bill and generates a corresponding detection signal. A control unit is connected with a counting unit and the detection unit. The control unit receives the detection signal and sets a pre-set period of time to the counting unit. At least one power output port is connected with the control unit and outputs electric power according to the time counted by the counting unit. The at least one power output port is stopped when the pre-set period of time is ended.

Preferably, the control unit is connected with a first light unit and a second light unit. When the control unit receives the detection signal and the at least one power output port does not yet output electric power, the first light unit is turned on. When the at least one power output port outputs electric power, the first light unit is shut off and the second light unit is turned on. When the pre-set period of time is ended, the second light unit is turned off.

Preferably, the first light unit is a green light and the second light unit is a red light.

Preferably, the at least one power output port outputs alternating current or direct current.

Preferably, the at least one power output port is an electric vehicle charging plug.

Preferably, the at least one power output port is a cellular phone charging plug.

Preferably, the at least one power output port is a battery charging plug.

Preferably, the control unit is connected to a display unit which displays the pre-set period of time and status of the counting unit.

Preferably, the body has a base connected to the underside thereof.

Preferably, the body has a hanging portion on the top thereof.

The primary object of the present invention is to provide a toll charging device which can be installed to tourist areas or stores so as to charge electric vehicles, electric bicycles, cellular phones or batteries by input coins or bills to the device, the toll charging device supplies direct current or alternating current according to the value of the coins or the bills. The higher value of the coins or the bills, the charging time is longer, so that the needs for charging objects can be met and the owners have income from the toll charging device.

The toll charging device of the present invention has the following advantages:

The toll charging device is suitable to be installed in tourist areas or stores so as to charge electric vehicles, electric bicycles, cellular phones or batteries so as to get carbon reduction.

The power output port of the toll charging device outputs alternating current or direct current, and the power output port can be an electric vehicle charging plug, a cellular phone charging plug, or a battery charging plug such that the toll charging device can charge electric vehicles, electric bicycles, cellular phones or batteries.

The toll charging device has the first light unit and the second light unit so that the users are acknowledged the charging status.

The toll charging device has a hanging portion which can hang the toll charging device on a wall so that the owner can remove the toll charging device and store the device easily when the store is closed. The toll charging device is then hanged on the wall when the store is opened. By this feature, the toll charging device does not worry about being stolen.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a block diagram to show the structure of the toll charging device of the present invention;

FIG. 2 is a perspective view to show the toll charging device of the present invention;

FIG. 3 is a perspective view to show that the toll charging device of the present invention charges an electric vehicle;

FIG. 4 is a perspective view to show that the toll charging device of the present invention charges an electric motorcycle;

FIG. 5 is a perspective view to show that the toll charging device of the present invention has a cellular phone charging plug;

FIG. 6 is a perspective view to show that the toll charging device of the present invention charges a cellular phone;

FIG. 7 is a perspective view to show that the toll charging device of the present invention has two charging clamps;

FIG. 8 is a perspective view to show that the toll charging device of the present invention charges a battery;

FIG. 9 is a perspective view to show that the toll charging device of the present invention has a power cable and an electric vehicle charging plug;

FIG. 10 is a perspective view to show that the power cable of the toll charging device of the present invention is connected to the receptacle on the wall, and

FIG. 11 is a perspective view to show that the toll charging device of the present invention has a hanging portion.

### DETAILED DESCRIPTION OF THE PREFERRED EMBODIMENT

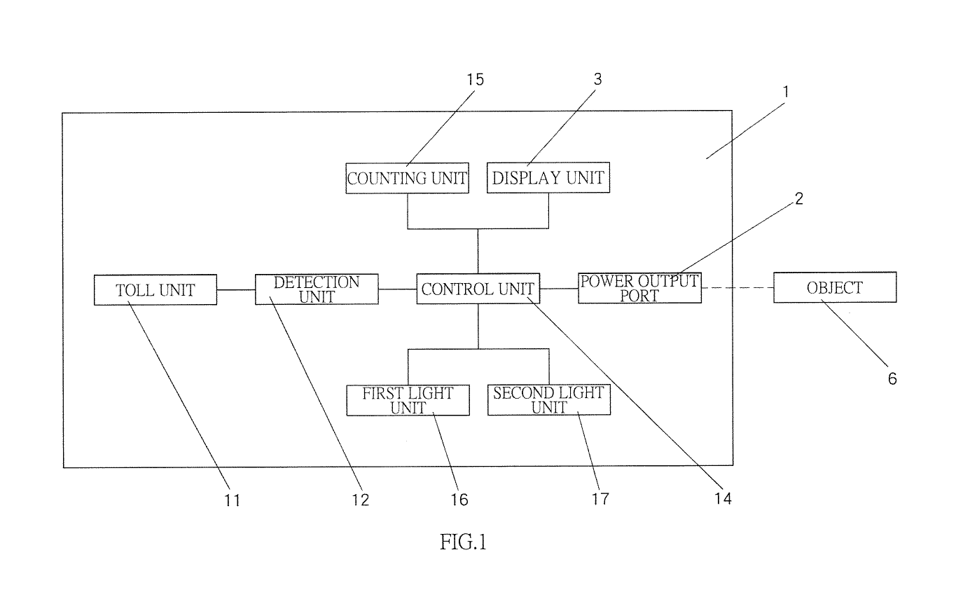

Referring to FIGS. 1 to 4, the toll charging device of the present invention comprises a body 1 having a toll unit 11 which is connected with a detection unit 12. The detection unit 12 detects the value of a coin/bill and generates a corresponding detection signal. The body 1 has a base 133 connected to the underside thereof.

A control unit 14 is connected with a counting unit 15 and the detection unit 12. The control unit 14 receives the detection signal and sets a pre-set period of time to the counting unit 15.

At least one power output port 2 is connected with the control unit 14 and outputs electric power according to the time counted by the counting unit 15. The at least one power output port 2 is stopped when the pre-set period of time is ended. The at least one power output port 2 outputs Alternating Current (AC) or Direct Current (DC). The at least one power output port 2 is an electric vehicle charging plug 2a.

The control unit 14 is connected with a first light unit 16 and a second light unit 17. When the control unit 14 receives the detection signal and the at least one power output port 2 does not yet output electric power, the first light unit 16 is turned on. When the at least one power output port 2 outputs electric power, the first light unit 16 is shut off and the second light unit 17 is turned on. When the pre-set period of time is ended, the second light unit 17 is turned off. The first light unit 16 is a green light and the second light unit 17 is a red light.

The control unit 14 is connected to a display unit 3 which displays the pre-set period of time and status of the counting unit 15.

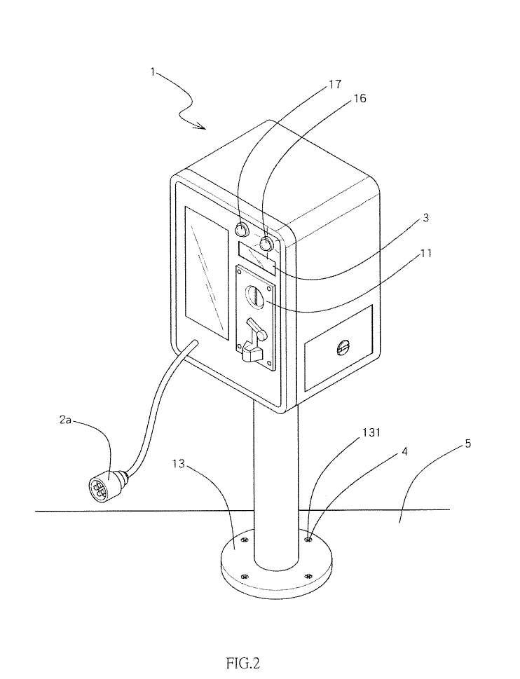

As shown in FIGS. 1 and 2, the toll charging device is suitable to be installed in tourist areas or stores, and is powered by the urban power source with the range of the voltage from 110V to 220V. The base 13 has multiple holes 131 and bolts 4 extend through the holes 131 to fix the body 1 on the ground 5. When the objects 6 to be charged have low battery level, the toll charging devices can be easily found and the objects 6 are charged.

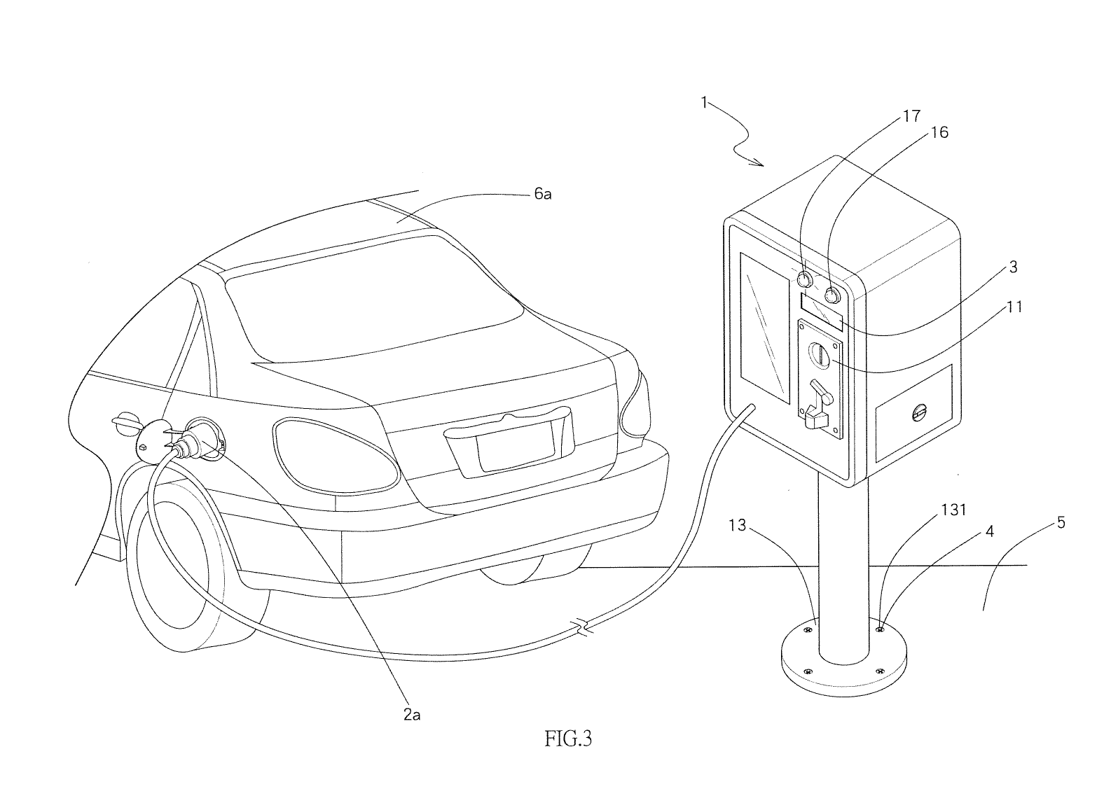

As shown in FIGS. 2 and 3, if the object 6 to be charged is an electric vehicle 6a and the vehicle needs to be charged, the user simply puts coins into the toll device 11 and the detection unit 12 detects the coins and generates a corresponding detection signal which is sent to the control unit 14. The control unit 14 receives the detection signal and sets a pre-set period of time to the counting unit 15. For example, the detection unit 12 detects the weight or size of the coins and judges the value. The higher the value of the coin is, the longer the charging time is obtained. When the control unit 14 receives the detection signal and the at least one power output port 2 does not yet output electric power, the first light unit 16 is turned on and the display unit 3 shows the period of time and the status of the counting unit 15. Because the at least one power output port 2 does not yet output electric power, the counting does not start. As shown in FIG. 3, when the at least one power output port 2 outputs electric power to the electric vehicle 6a, the counting unit 15 starts to count the time, and the first light unit 16 is shut off and the second light unit 17 is turned on. When the pre-set period of time is ended, the at least one power output port 2 stop to output electric power, and the second light unit 17 is turned off. By the first light unit 16 and the second light unit 17, the user is acknowledged the charging status to the electric vehicle.

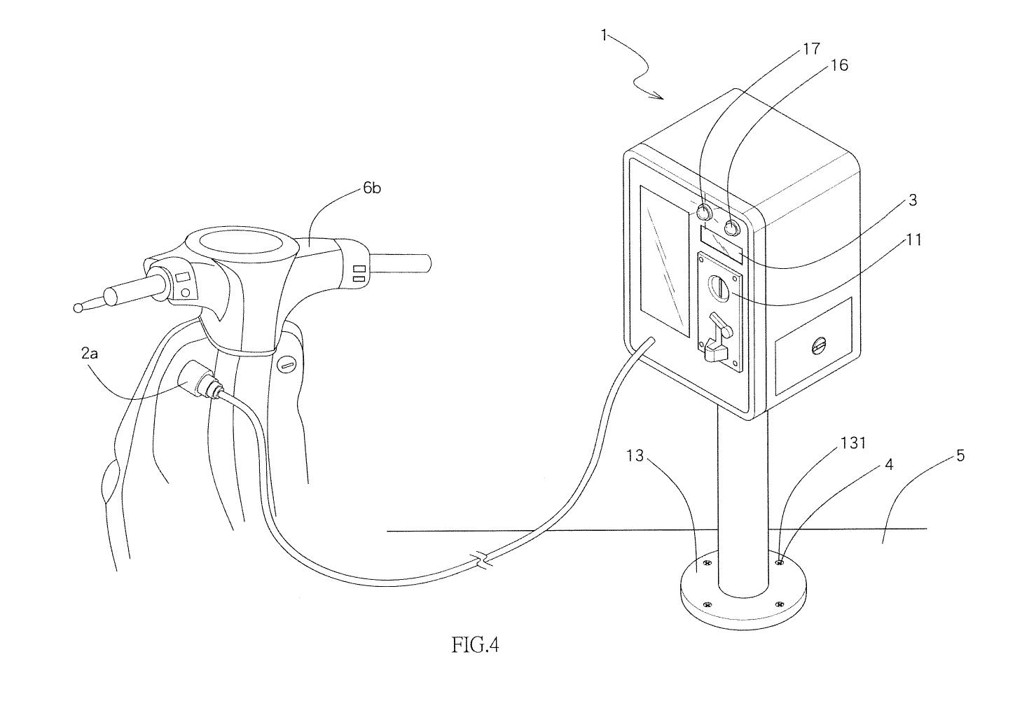

FIG. 4 shows the second embodiment of the present invention wherein the difference is that the object 6 to be charged is an electric motorcycle 6b. The operation of the present invention is similar to the first embodiment and will not be described in detail.

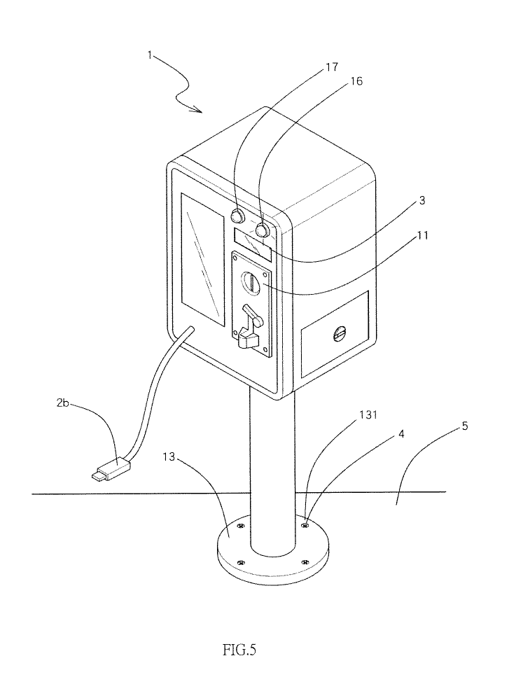

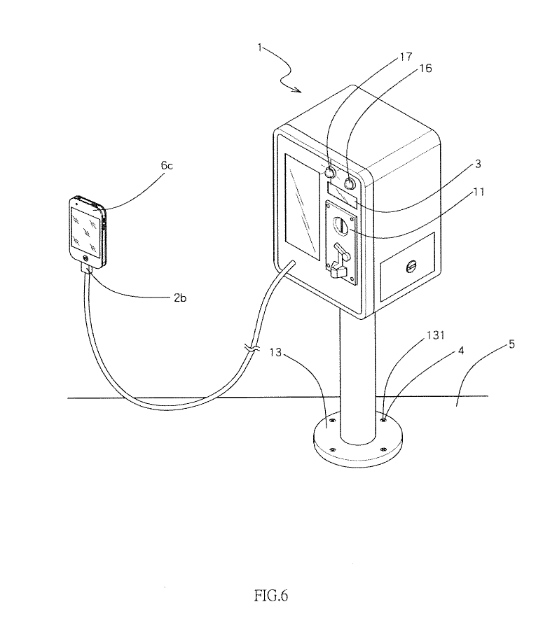

FIGS. 5 and 6 show the third embodiment of the present invention wherein the difference is that the at least one the at least one power output port 2 is a cellular phone charging plug 2b, and the object 6 to be charged is a cellular phone 6c. When the cellular phone 6c needs to be charged, the user can find one of the toll charging devices to charge the cellular phone 6c.

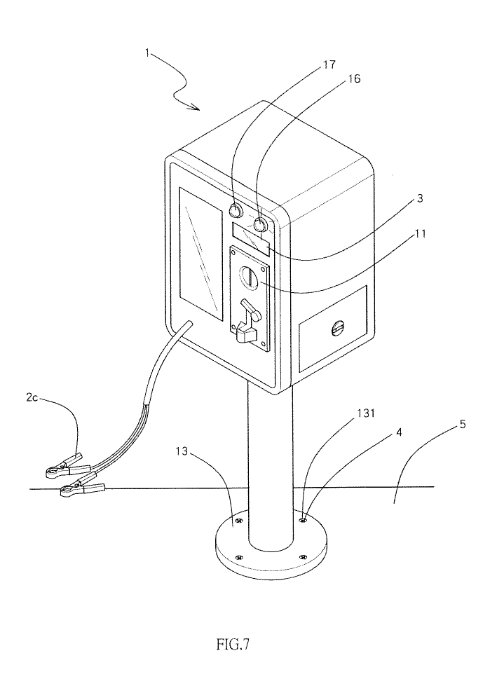

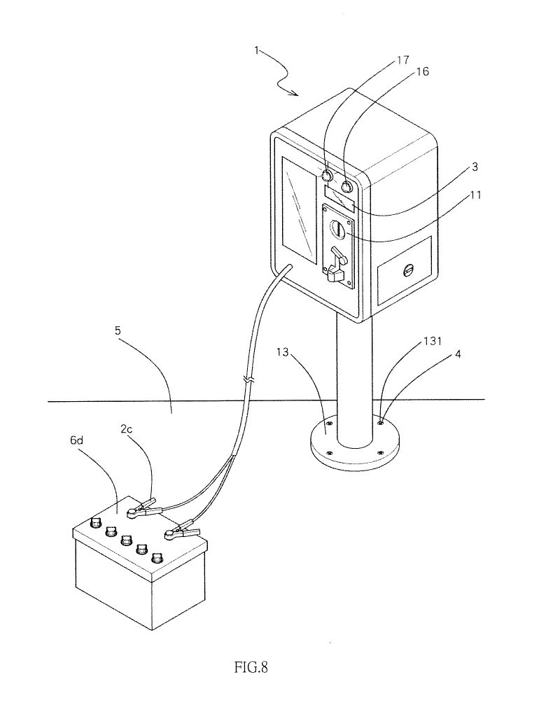

FIGS. 7 and 8 show the fourth embodiment of the present invention wherein the difference is that the at least one the at least one power output port 2 is a battery charging plug 2c, and the object 6 to be charged is a battery 6d. When the user uses a vehicle using gasoline, and the battery 6d is too low to start the engine, the battery 6d can be charged in one of the toll charging devices.

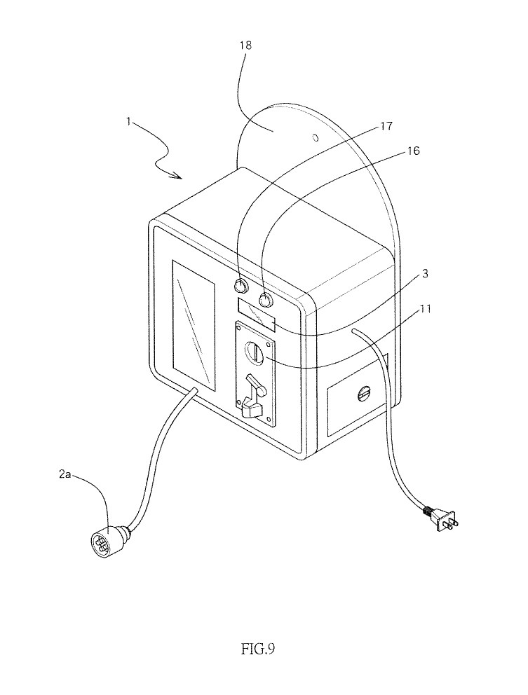

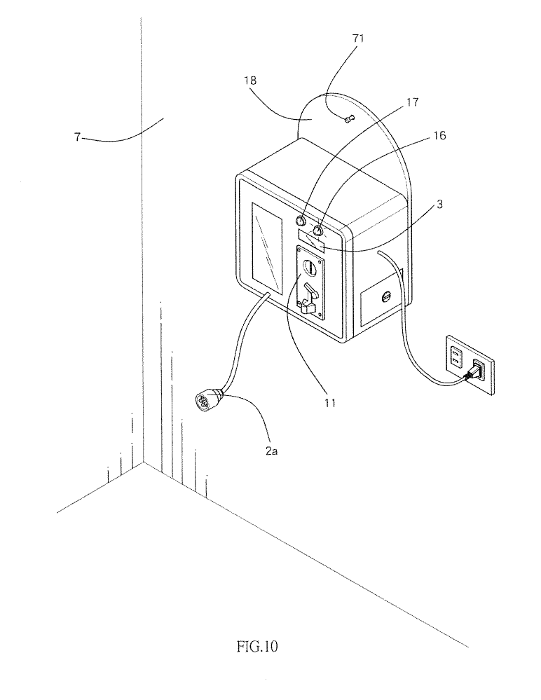

FIGS. 9 and 10 show the fifth embodiment of the present invention wherein the difference is that the body 1 has a hanging portion 18 on the top thereof. The hanging portion 18 is a board and the body 1 can be hanged on a fixed member 71 on a wall 7 by the hanging portion 18. If the area is located in an insecurity area and there is no one to manage the store after the store is closed, such as in the night time, the owner can easily move the toll charging device from the fixed member on the wall 7 and stored in a safety place. When the store is opened, the body 1 can be hanged on the fixed member 71 on the wall 7 again.

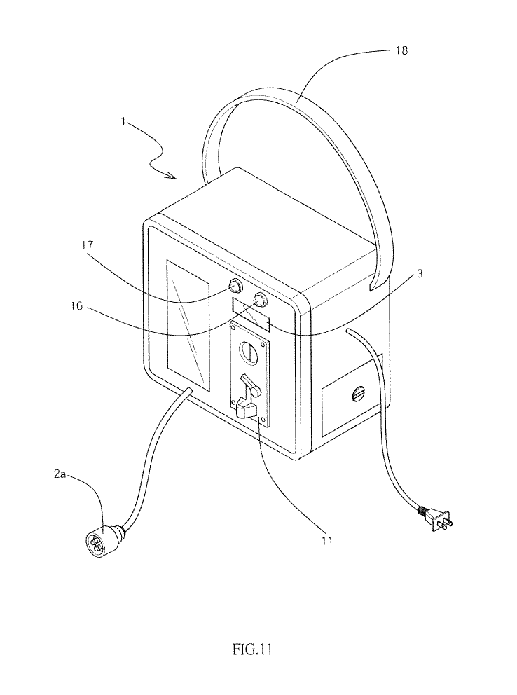

FIG. 11 shows show the sixth embodiment of the present invention wherein the difference is that the hanging portion 18 on the top of the body 1 is a strap. The operation of the above mentioned embodiments of the present invention is similar to the first embodiment and will not be described in detail.

While we have shown and described the embodiment in accordance with the present invention, it should be clear to those skilled in the art that further embodiments may be made without departing from the scope of the present invention.

What is claimed is:

1. A toll charging device comprising:
a body having a toll unit which is connected with a detection unit, the detection unit detecting a value of a coin/bill and generating a corresponding detection signal;
a control unit connected with a counting unit and the detection unit, the control unit receiving the detection signal and setting a pre-set period of time to the counting unit, and
at least one power output port connected with the control unit and outputting electric power according to time counted by the counting unit, the at least one power output port being stopped when the pre-set period of time is ended.

2. The device as claimed in claim 1, wherein the control unit is connected with a first light unit and a second light unit, when the control unit receives the detection signal and the at least one power output port does not yet output electric power, the first light unit is turned on, when the at least one power output port outputs electric power, the first light unit is shut off and the second light unit is turned on, when the pre-set period of time is ended, the second light unit is turned off.

3. The device as claimed in claim 2, wherein the first light unit is a green light and the second light unit is a red light.

4. The device as claimed in claim 1, wherein the at least one power output port outputs alternating current or direct current.

5. The device as claimed in claim 1, wherein the at least one power output port is an electric vehicle charging plug.

6. The device as claimed in claim 1, wherein the at least one power output port is a cellular phone charging plug.

7. The device as claimed in claim 1, wherein the at least one power output port is a battery charging plug.

8. The device as claimed in claim 1, wherein the control unit is connected to a display unit which displays the pre-set period of time and status of the counting unit.

9. The device as claimed in claim 1, wherein the body has a base connected to an underside thereof.

10. The device as claimed in claim 1, wherein the body has a hanging portion on a top thereof.
